(19) United States
(12) Patent Application Publication
(10) Pub. No.: US 2025/0214509 A1
(43) Pub. Date: Jul. 3, 2025

(54) VEHICULAR INTERIOR MIRROR WITH TILT ACTUATOR

(71) Applicant: Magna Mirrors of America, Inc., Holland, MI (US)

(72) Inventor: Anthony J. LaCross, Hastings, MI (US)

(21) Appl. No.: 18/987,113

(22) Filed: Dec. 19, 2024

Related U.S. Application Data
(60) Provisional application No. 63/615,307, filed on Dec. 28, 2023.

(51) Int. Cl. B60R 1/08; B60R 1/12

(52) U.S. Cl. CPC B60R 1/087; B60R 1/12; B60R 2001/1253

(57) ABSTRACT

A vehicular interior rearview mirror assembly includes a mounting base and a mirror head accommodating a mirror reflective element. An adjustment mechanism is operable to adjust the mirror head between a first orientation and a second orientation. The adjustment mechanism includes an electrically operable motor that drives a main gear, a torque element, an output element coupled to the mirror head and a biasing element coupled to the torque element. With the mirror head in the first orientation, during a first stage of operation of the motor, the motor drives the main gear in a first direction and generates a biasing force at the torque element. During a second stage of operation of the motor, the motor drives the main gear further in the first direction and the biasing force imparts movement of the torque and output element to adjust the mirror head toward the second orientation.

### CROSS REFERENCE TO RELATED APPLICATION

The present application claims the filing benefits of U.S. provisional application Ser. No. 63/615,307, filed Dec. 28, 2023, which is hereby incorporated herein by reference in its entirety.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a single ball pivot or joint mounting configuration or double ball pivot or joint mounting configuration where the mirror casing and reflective element are adjusted relative to the interior portion of a vehicle by pivotal movement about the single or double ball pivot configuration. The mirror casing and reflective element are pivotable about either or both of the ball pivot joints by a user that is adjusting a rearward field of view of the reflective element. It is also generally known to provide an interior mirror assembly with a prismatic reflective element that may be manually toggled between daytime and nighttime reflectivity positions, such as described in U.S. Pat. No. 6,318,870, which is hereby incorporated herein by reference in its entirety.

### SUMMARY OF THE INVENTION

An interior rearview mirror assembly for a vehicle includes a mounting structure configured to attach to an interior portion of a cabin of a vehicle equipped with the vehicular interior rearview mirror assembly. A mirror head accommodates a prismatic mirror reflective element. The prismatic mirror reflective element comprises a wedge-shaped glass substrate and a mirror reflector coating disposed at a rear side of the wedge-shaped glass substrate. With the mounting structure attached at the interior portion of the cabin of the vehicle, the mirror head is adjustable by a driver of the vehicle to set a rearward view for the driver. A toggle mechanism that, with the mounting structure attached at the interior portion of the cabin of the vehicle, is operable to adjust the mirror head between (i) a daytime orientation, where the mirror head is positioned relative to the mounting structure so that reflections at the mirror reflector coating provide the rearward view for the driver, and (ii) a nighttime orientation, where the mirror head is tilted from the daytime orientation so that reflections at the mirror reflector coating are directed away from the driver. The toggle mechanism includes (i) an electrically operable motor that drives a main gear, (ii) a torque element having a biasing element and (iii) an output element coupled to the mirror head. With the mirror head in the daytime orientation, the electrically operable motor is electrically operated to drive the main gear in a first direction and generate a biasing force between the biasing element and the torque element. With the mirror head in the daytime orientation, and with the biasing force generated between the biasing element and the torque element, and responsive to further electrical operation of the electrically operable motor to drive the main gear further in the first direction, the biasing force imparts movement of the torque element and the output element to adjust the mirror head from the daytime orientation to the nighttime orientation.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly with a mirror reflective element having a prismatic glass substrate;

FIG. 2 is a perspective view of a toggle mechanism with an electrically operable actuator configured to adjust the mirror assembly relative to a socket element between a daytime orientation and a nighttime orientation;

FIG. 3A is a perspective view of a torque mechanism of the toggle mechanism, with the torsion spring of the torque mechanism wound in a first direction;

FIG. 3B is a perspective view of the torque mechanism, with the torsion spring wound in a second direction opposite the first direction;

FIG. 4A is a perspective view of the toggle mechanism, with the torsion spring in a default or unwound position, a detent interface between a main gear and the torque mechanism engaged, and a clutch interface between the torque mechanism and an output cam disengaged;

FIG. 4B is a perspective view of the toggle mechanism, with the torsion spring wound in the first direction, the detent interface between the main gear and the torque mechanism engaged, and the clutch interface between the torque mechanism and the output cam disengaged;

FIG. 4C is a perspective view of the toggle mechanism, with the torsion spring wound in the first direction, the detent of the main gear moved along the detent of the torque mechanism, and the clutch interface between the torque mechanism and the output cam engaged;

FIG. 4D is a perspective view of the toggle mechanism, with the detent interface between the main gear and the torque mechanism disengaged to allow the torsion spring to unwind and rotate the torsion mechanism to the unwound position and impart movement of the output cam via the engaged clutch interface between the torque mechanism and the output cam;

FIG. 4E is a perspective view of the toggle mechanism, with the torsion spring wound in the second direction, the detent interface between the main gear and the torque mechanism reengaged, and the clutch interface between the torque mechanism and the output cam disengaged;

FIG. 5A is a perspective view of the toggle mechanism and socket element, with the torsion spring wound in the second direction, the detent interface between the main gear and the torque mechanism engaged, and the clutch interface between the torque mechanism and the output cam disengaged;

FIG. 5B is a perspective view of the toggle mechanism and socket element, with the torsion spring in the unwound position, the detent interface between the main gear and the torque mechanism engaged, and the clutch interface between the torque mechanism and the output cam disengaged;

FIG. 5C is a perspective view of the toggle mechanism and socket element, with the torsion spring wound in the first direction, the detent of the main gear moved along the detent of the torque mechanism, and the clutch interface between the torque mechanism and the output cam engaged;

FIG. 6 is a perspective view of the output cam with a pin at the toggle body received along an arcuate slot of the output cam; and

FIG. 7 is a perspective view of a detent at an inner surface of the toggle body engaging a detent at the output cam to prevent rotation of the output cam when the clutch interface is disengaged.

### DESCRIPTION OF THE PREFERRED EMBODIMENTS

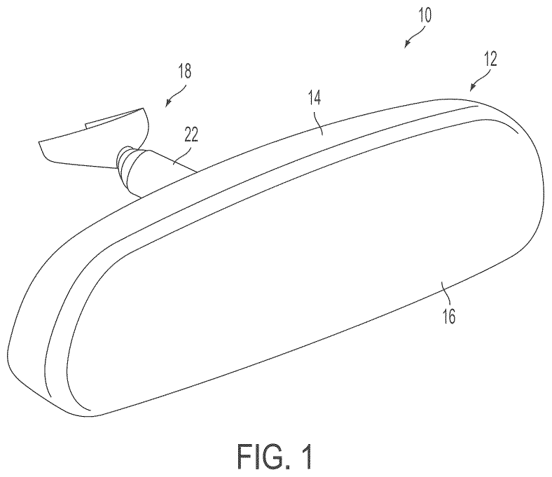

Referring now to the drawings and the illustrative embodiments depicted therein, a vehicular interior rearview mirror assembly 10 includes a mirror head 12 that includes a casing 14 and a reflective element 16 positioned at a front portion of the casing 14 (FIG. 1). In the illustrated embodiment, the mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly 18. The mirror reflective element 16 may comprise a prismatic mirror reflective element that comprises a wedge-shaped glass substrate that can be flipped between a daytime orientation and a nighttime or anti-glare orientation.

That is, the mirror reflective element 16 may comprise a prismatic glass substrate having a front or first surface (the surface that generally faces the driver of the vehicle when the mirror assembly is normally mounted at the vehicle) and a rear or second surface opposite the first surface, where the first surface and the second surface are at an oblique angle relative to one another. A mirror reflector coating may be disposed at the second surface for providing reflections for viewing by the driver of the vehicle. The mirror head 12 is adjustable at least between the daytime mirror mode orientation, where the mirror head is configured to provide a brighter reflection at the mirror reflective element 16 for viewing by the driver (e.g., the reflection is from the second surface) and the nighttime mirror mode orientation, where the mirror head is tilted upward from the daytime mirror mode orientation (e.g., five degrees) to provide a dimmer reflection at the mirror reflective element 16 for viewing by the driver (e.g., the reflection is from the first surface). As discussed further below, the mirror assembly 10 includes a toggle mechanism or actuator 20 that is electrically operable to adjust the mirror head 12 between at least the daytime orientation and the nighttime orientation, such as responsive to a user input or automatically based on detection of glare light at the mirror reflective element.

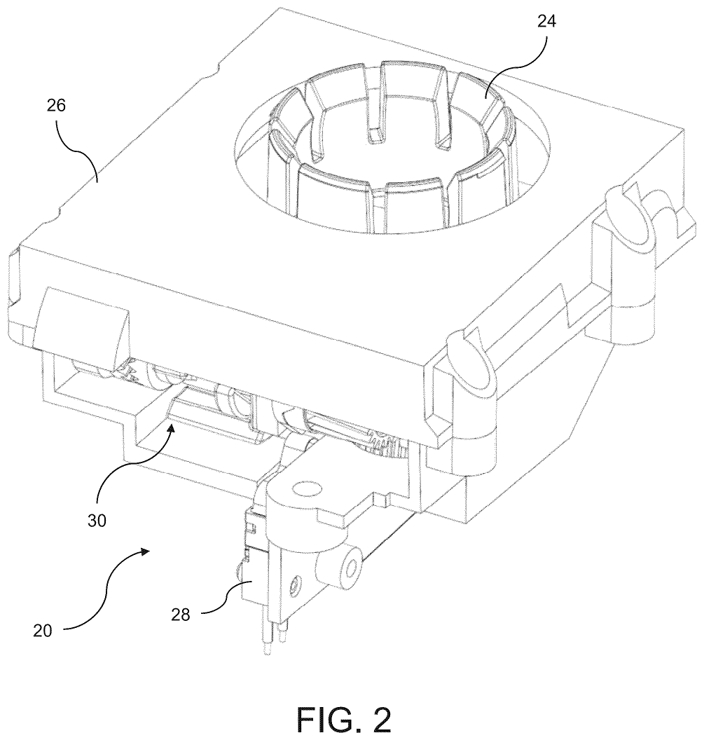

The mounting structure 18 of the mirror assembly 10 allows for the mirror head 12 to pivot between the daytime orientation and the nighttime orientation. For example, the mounting structure 18 includes a mounting arm or stay 22 configured to mount at the interior portion of the vehicle and having a ball member at an end of the mounting arm 22. The ball member of the mounting arm 22 is pivotally received in a socket element 24 (FIG. 2) that is attached at or integrally formed with the mirror head 12. For example, the socket element 24 may be attached at or integrally formed with the mirror casing 14 or a mirror back plate attached to the mirror reflective element 16 or other suitable structure of the mirror head 12.

When the mirror head 12 is adjusted relative to the mounting structure 18 to adjust the rearward field of view provided by the mirror reflective element 16, the socket element 24 allows for pivoting of the mirror head 12 about the ball member. That is, the mirror head 12 and the socket element 24 may pivot about the ball member. When the mirror head 12 is adjusted between the daytime orientation and the nighttime orientation, the mirror head 12 tilts or pivots upward and/or downward relative to the socket element 24 and the mirror head 12 may pivot about a pivot axis that is parallel to a longitudinal axis of the mirror head 12. In other words, when the mirror head 12 is adjusted between the daytime and nighttime orientations, the position of the socket element 24 relative to the ball member may be maintained and the mirror head 12 pivots relative to the socket element 24. For example, the socket element 24 may be pivotally attached to the mirror back plate or mirror casing 14 or a toggle body 26 at the mirror head 12 and, when the mirror head 12 is toggled between the daytime orientation and the nighttime orientation, the toggle body 26 pivots relative to the socket element 24 to move the mirror head 12. As discussed further below, the mirror head 12 may be further pivoted from the daytime orientation and/or the nighttime orientation to a display mode orientation, where reflections from the first surface and the second surface of the mirror reflective element 16 are directed away from view of the driver and a video display screen accommodated within the mirror head is electrically operated to display video images viewable to the driver through the mirror reflective element.

Referring to FIGS. 2-7, the toggle actuator 20 is accommodated within the mirror head 12, such as at or within the toggle body 26, and includes a motor 28 that is electrically operable to pivot the structure 26 relative to the socket element 24 to move the mirror head 12 between the daytime orientation and the nighttime orientation. To provide a quicker transition between the daytime orientation and the nighttime orientation, the motor 28 drives a gear train that in turn drives a clutch mechanism or assembly 30 coupled to an output element 32 at the structure 26, where the clutch assembly 30 stores energy from operation of the motor 28 and releases the energy to move the output element 32 and adjust or flip the mirror head 12 between the daytime orientation and the nighttime orientation. That is, rather than have the motor 28 directly tied to the output of the actuator 20 and drive the movement of the mirror head 12 directly, the clutch assembly 30 is between the gear train of the motor 28 and the output member 32 of the actuator 20. The clutch assembly 30 may store energy, such as over the course of few seconds during operation of the motor, and hold it until the transition between the daytime orientation and the nighttime orientation is actuated.

The clutch assembly 30 includes a main gear 34 that is driven by the motor 28 via the gear train. The main gear 34 includes a detent surface 34a that engages a corresponding detent surface 36a of a torque element 36. A biasing element 38, such as a torsion spring, is disposed about the torque element 36. When the detent interface between the main gear 34 and the torque element 36 is engaged, the main gear 34 drives the torque element 36 and the torsion spring 38 is wound about the torque element 36. For example, the torque element 36 extends through or at least partially within a housing 40 and the torsion spring 38 is disposed about the torque element 36 within the housing 40. The housing 40 includes a first circumferential engagement portion 40a that is radially aligned with a first end 38a of the torsion spring 38 and partially circumscribes the torsion spring 38 at the first end 38a and a second circumferential engagement portion 40b that is radially aligned with an opposite second end 38b of the torsion spring 38 and partially circumscribes the torsion spring 38 at the second end 38b. A torque arm or bar 42 extends from and is rotationally fixed to the torque element 36, where the torque arm 42 extends along the torsion spring 38 and is radially outboard of the first and second circumferential engagement portions of the housing 40. The first end 38a and the second end 38b of the torsion spring 38 extend along opposing sides of the torque arm 42.

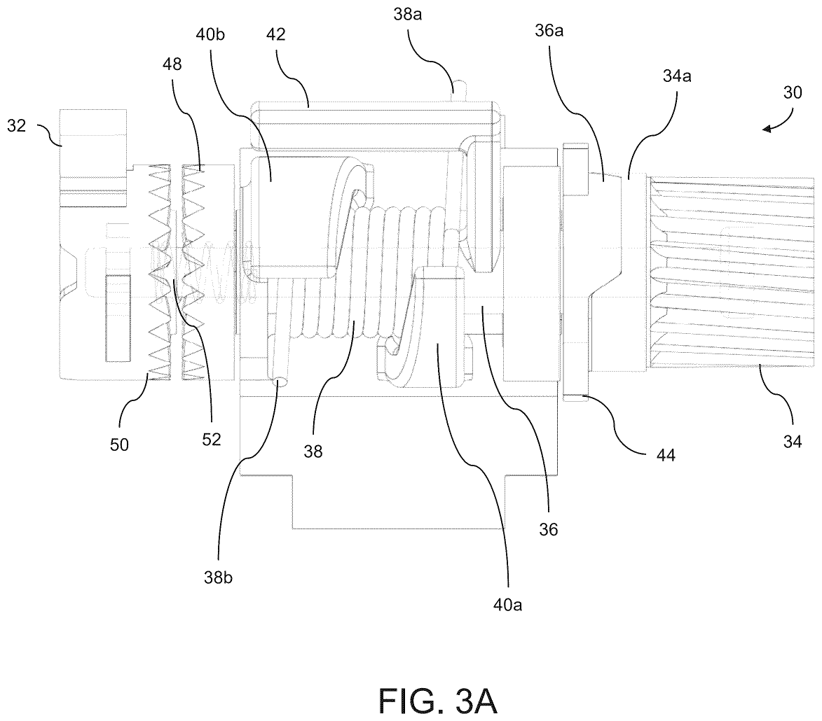

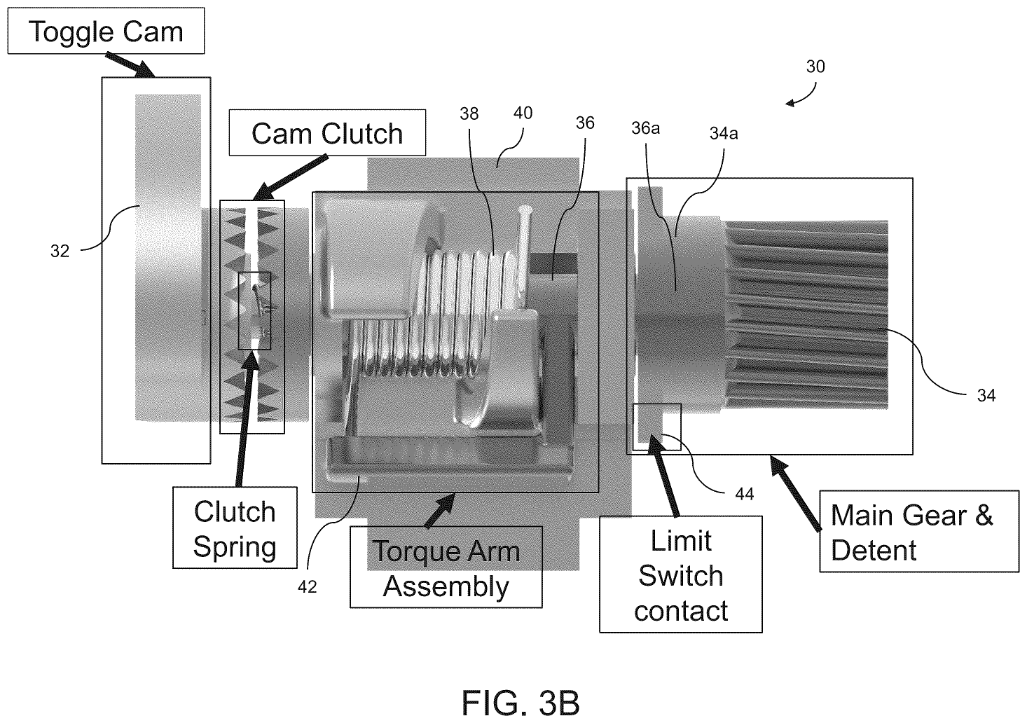

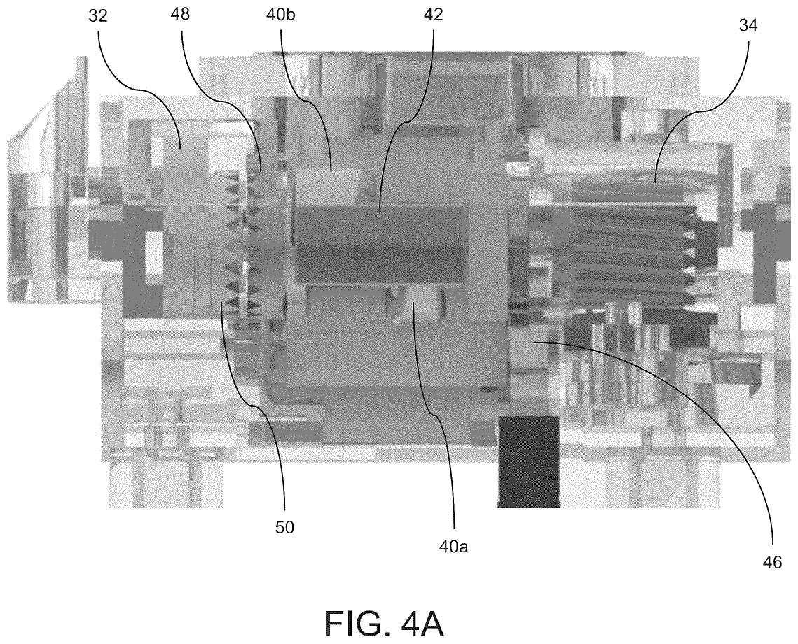

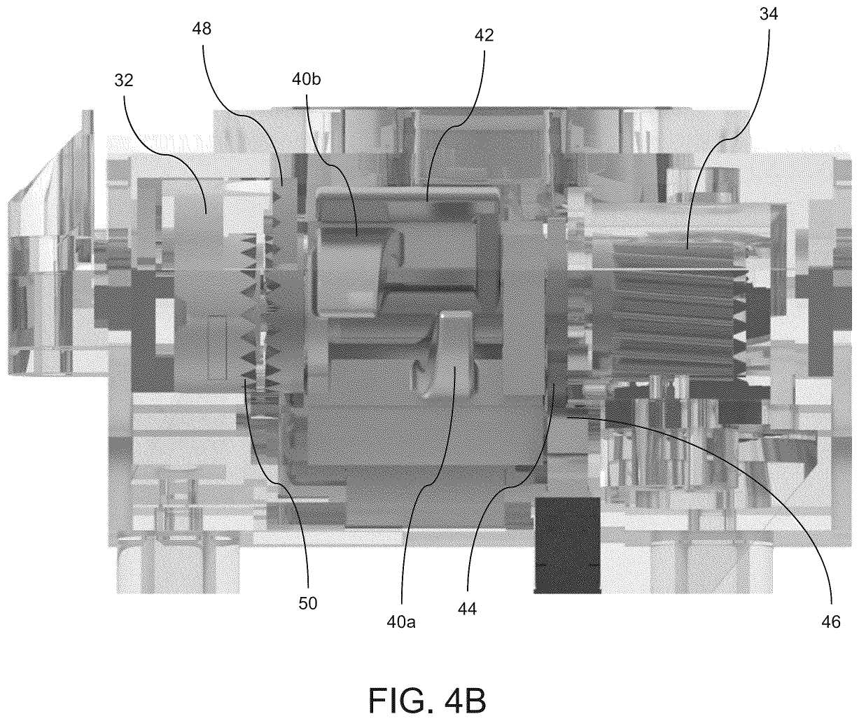

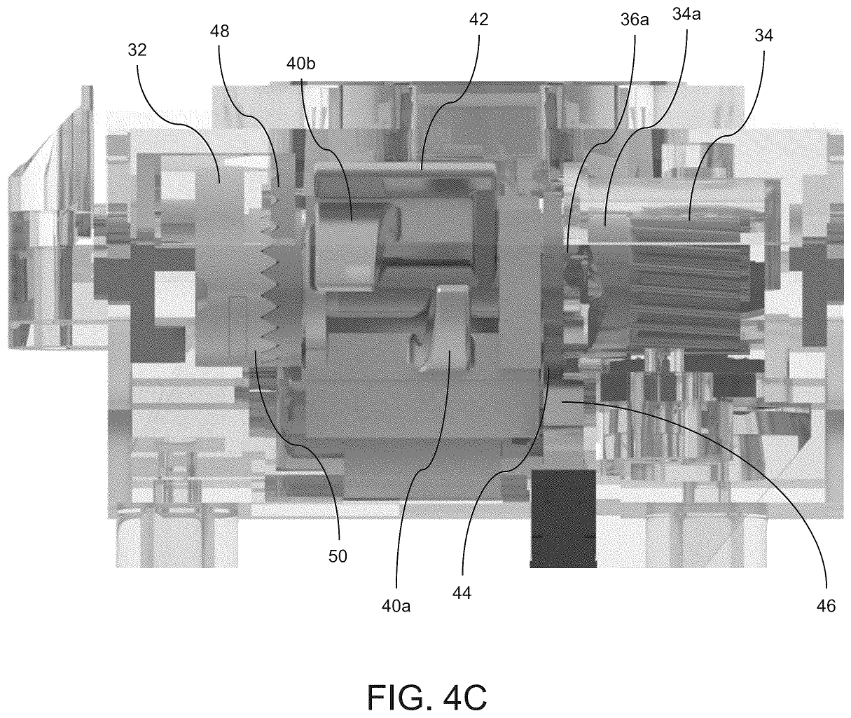

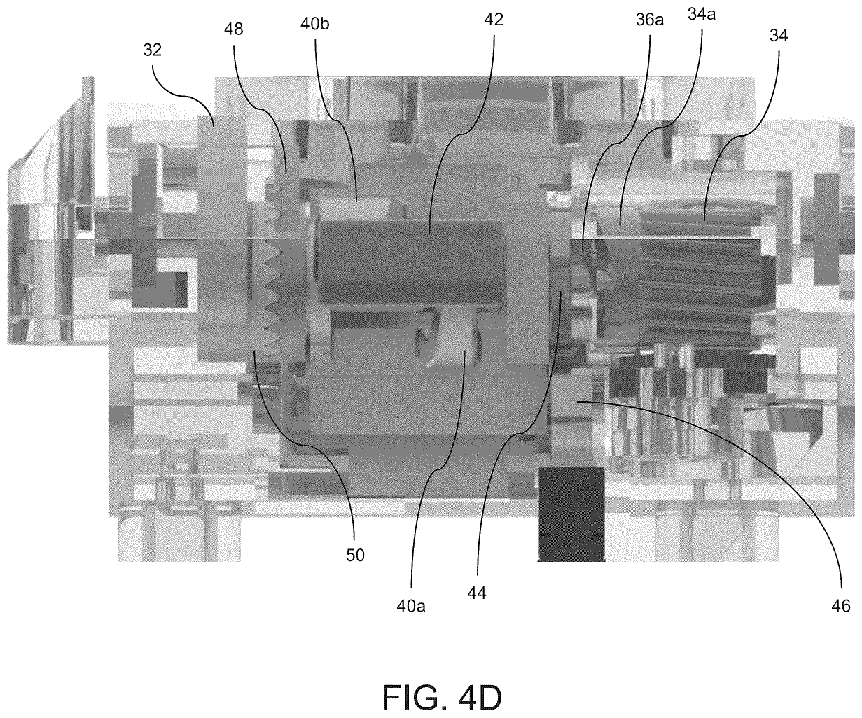

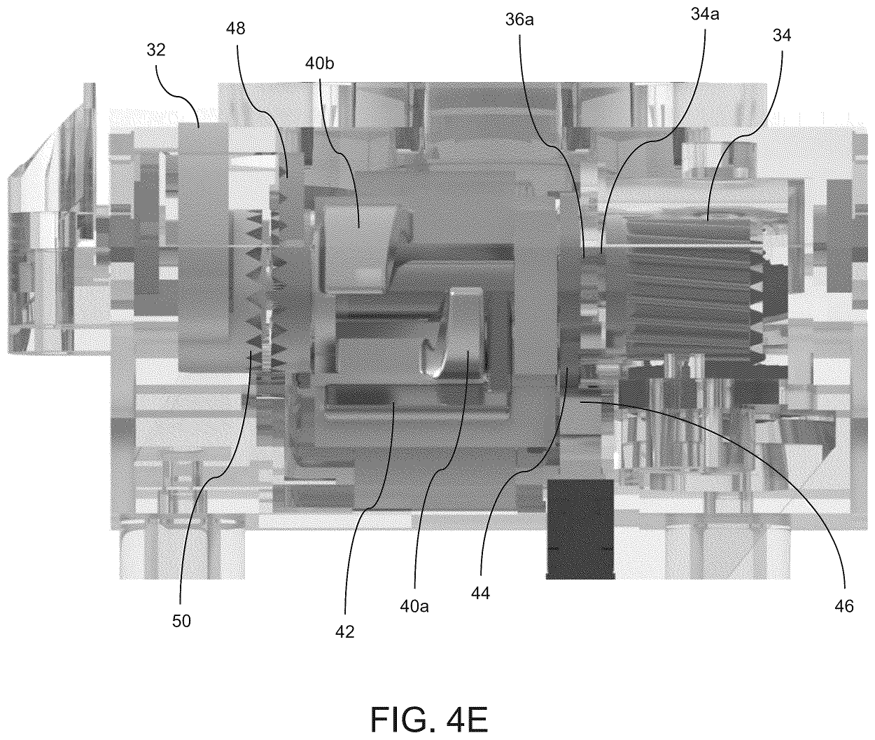

As the main gear 34 rotates the torque element 36 and the torque arm 42 relative to the housing 40 in a first direction from a default or unwound position (FIG. 4A), the first end 38a of the torsion spring 38 engages the first circumferential engagement portion 40a of the housing 40 to fix the first end 38a of the torsion spring 38 relative to the housing 40 and the torque arm 42 engages the second end 38b to wind the torsion spring 38 and increase the biasing force of the torsion spring 38 in an opposite second rotational direction (FIGS. 3A and 4B). Similarly, as the main gear 34 rotates the torque element 36 and the torque arm 42 relative to the housing 40 in the second direction, the second end 38b of the torsion spring 38 engages the second circumferential engagement portion 40b of the housing 40 to fix the second end 38b of the torsion spring 38 relative to the housing 40 and the torque arm 42 engages the first end 38a to wind the torsion spring 38 and increase the biasing force of the torsion spring 38 in the first rotational direction (FIG. 3B). Thus, the torsion spring 38 may provide a biasing force against the torque arm 42 and the torque element 36 in either rotational direction depending on the direction in which the torsion spring 38 is wound. This allows the clutch assembly 30 to store energy via the torsion spring 38 that may be released for a quick transition between the daytime orientation and the nighttime orientation in either direction.

The motor 28 may be driven until a threshold biasing force is stored in the torsion spring 38. For example, a protrusion or tab or contact 44 may extend from the torque element 36 at or near the detent interface 36a so that, as the torque element 36 rotates, the contact 44 engages a switch 46 disposed within the mirror head 12. The switch 46 deactivates the motor 28 in response to engaging the contact 44. Thus, when the motor 28 drives the torque element 36 to wind the torsion spring 38, the motor 28 is active until the limit switch 46 is pressed, signaling the end of winding. The torsion spring 38 is thus at a maximum potential energy and the detent between the main gear 34 and the torque element 36 is engaged to hold the torsion spring load.

Thus, during a first stage of electrical operation of the motor 28, the main gear 34 may drive the torque element 36 relative to the biasing element 38 and the output cam 32 to wind the biasing element 38 and generate the biasing force at the torque element 36. As shown in FIG. 4B, with the torsion spring 38 wound and the mirror head 12 in the daytime orientation or the nighttime orientation, a first clutch element or interface 48 rotationally coupled to the torque element 36 is spaced from and/or disengaged from a second clutch element or interface 50 rotationally coupled to the output element or toggle cam 32. The second clutch element 50 and the cam 32 receive none of the torsion spring load when disconnected. For example, a clutch spring or biasing element, such as a coil spring 52 disposed between the first clutch element 48 and the second clutch element 50, biases the first clutch element 48 and the second clutch element 50 away from engagement with one another. With the first clutch element 48 and the second clutch element 50 disengaged, the second clutch element 50 and the cam 32 are rotationally fixed relative to the mirror head 12. For example, a detent or protrusion 54 extending from an inner surface of the toggle body 26 may engage a corresponding detent interface or recess 56 formed at the cam 32 to rotationally fix the cam 32 relative to the toggle body 26 (FIG. 7). The detent ensures that the cam 32 does not change positions (and thus the mirror head does not inadvertently change orientations) when the cam 32 is disconnected from the first clutch element 48.

To adjust the mirror head 12 between the daytime orientation and the nighttime orientation, the torsion spring 38 is wound during the first stage of electrical operation and then the motor 28 is driven further in the current winding direction during a second stage of electrical operation to rotate the main gear 34 relative to the torque element 36 (FIG. 4C). For example, the torque arm 42 may engage a stop element or portion of the housing 40 when the contact 44 engages the switch 46, causing the torque element 36 to stop rotating in the current direction and causing the main gear 34 to rotate relative to the torque element 36. This further movement of the main gear 34 causes the detent interface 34a at the main gear 34 to move along the detent interface 36a at the torque element 36, which causes axial movement of the main gear 34 away from the housing 40 and the torque element 36. As the main gear 34 lifts relative to the torque element 36, the second clutch element 50 moves into engagement with the first clutch element 48 and the detent 56 at the cam 32 moves out of engagement with the detent 54 at the toggle body 26. This connects the second clutch element 50 and the cam 32 to the spring load and allows the second clutch element 50 and the cam 32 to rotate. For example, the cam 32 and the main gear 34 may be coupled via a pin (e.g., that may extend through the torque element 36), which allows the main gear 34 and the cam 32 to rotate relative to one another, but translate together. Movement of the main gear 34 along the detent interface 36a of the torque element 36 with the clutch elements engaged transfers the spring load to the gear train, such that the clutch elements and the cam 32 do not rotate. That is, the torsion spring 38 remains at its max potential energy while the detent interface between the main gear 34 and the torque element 36 is engaged and the spring 38 remains loaded until the main gear detent interface 34a clears the detent ramp 36a of the torque element 36.

When the detent interface 34a of the main gear 34 releases from or clears the detent interface 36a of the torque element 36, the torsion spring 38 urges rotation of the torque element 36, the first clutch element 48, the second clutch element 50, and the cam 32, and the torque element 36 rotates until the torque arm 42 is in its neutral or unwound position (FIG. 4D). The motor 28 may continue to drive the main gear 34 in its current direction during the second stage until the switch 46 is depressed by the contact 44. Thus, when the detent interface at the main gear 34 and torque element 36 releases and is disengaged, this allows the torsion spring 38 to release its stored energy and the spring load is transferred to the cam 32. The torque arm 42 is pushed by the torsion spring 38 back to its neutral position and the cam 32 receives all the torsion spring load as the torsion spring 38 is not connected to the gear train.

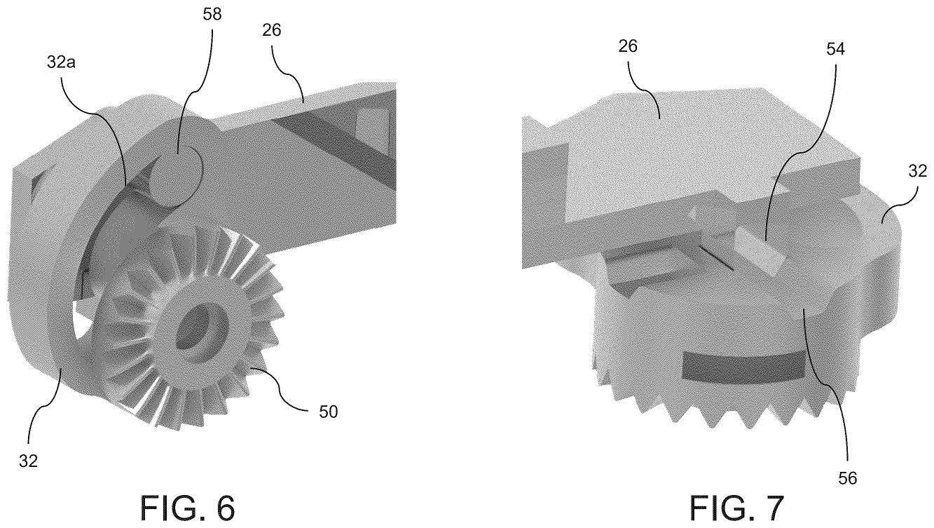

As shown in FIG. 6, the cam 32 may include an arcuate slot 32a that receives a pin or guide element 58 coupled to the socket element 24. The arcuate slot 32a may have an increasing radius from the pivot axis of the cam 32 so that, as the cam 32 rotates and the pin 58 moves along the slot 32a, the socket element 24 is pivoted relative to the mirror head 12 and thus the mirror head 12 is moved between the daytime and nighttime orientations. For example, the arcuate slot 32a may use Archimedean spiral geometry to tilt the mirror head relative to the stay. This geometry offers a mechanical advantage to prevent self-flip and head droop.

With the torsion spring 38 unwound and the mirror head 12 adjusted to the daytime orientation or the nighttime orientation, the motor 28 is operated during a third stage of electrical operation to drive the gear train and main gear 34 in the opposite direction to rewind the torsion spring 38 and prepare for the next switch of the mirror head 12 (FIG. 4E). As the motor 28 is driven in the opposite direction, the main gear 34 rides along the detent interface 36a of the torque element 36 and the biasing element 52 urges the second clutch element 50 and the cam 32 out of engagement with the first clutch element 48. That is, the biasing element 52 forces the clutch elements to disengage while driving the cam 32 into a detent with the toggle body, and while also forcing the main gear 34 into detent with the torque element 36. This may disconnect rotation of the main gear 34 and the torque element 36 from the cam 32 with the detent 54 of the toggle body 26 reengaging the detent interface 56 of the cam 32 to maintain the orientation of the mirror head 12.

Thus, the detent interface 34a of the main gear 34 reengages the detent interface 36a of the torque element 36 and the main gear 34 rotates the torque element 36 relative to the cam 32 to rewind the torsion spring 38. The motor 28 is active during the third stage until the limit switch 46 is pressed by the contact 44, signaling the end of winding. Thus, the torsion spring 38 reaches its max potential energy and the main detent is engaged to hold the torsion spring load. The clutch elements are disconnected and the cam 32 receives none of the torsion spring load. The detent between the cam 32 and the toggle body 26 is engaged to prevent accidental movement of the mirror head between the daytime and nighttime orientations. Similar to the second stage, a fourth stage of electrical operation of the motor 28 drives the main gear 34 further in the second direction to cause the main gear 34 to move relative to the torque element 36. This causes the first clutch interface 48 and the second clutch interface 50 to engage so that, when the detent between the main gear 34 and the torque element 36 is released, the biasing force stored in the torsion spring 38 is released and causes the torque element 36 and the cam 32 to rotate and move the mirror head between the daytime and nighttime orientation.

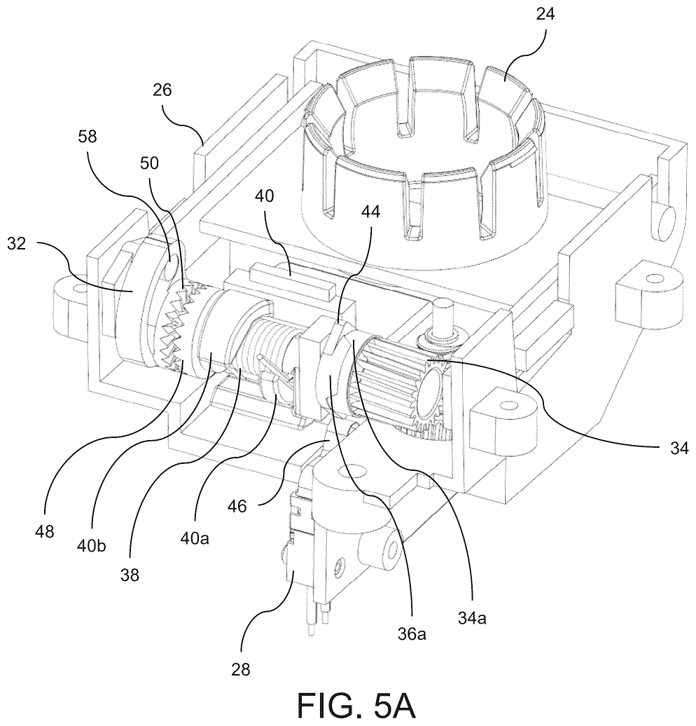

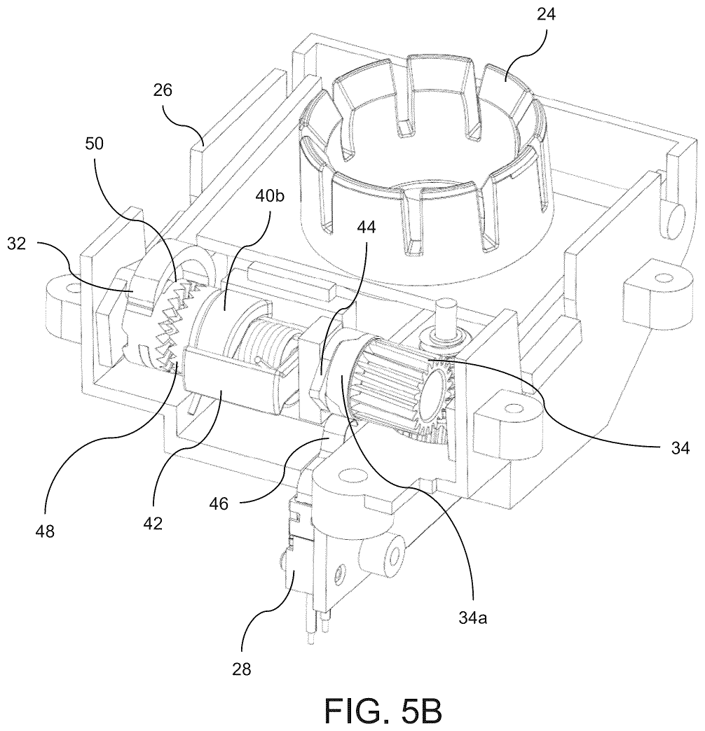

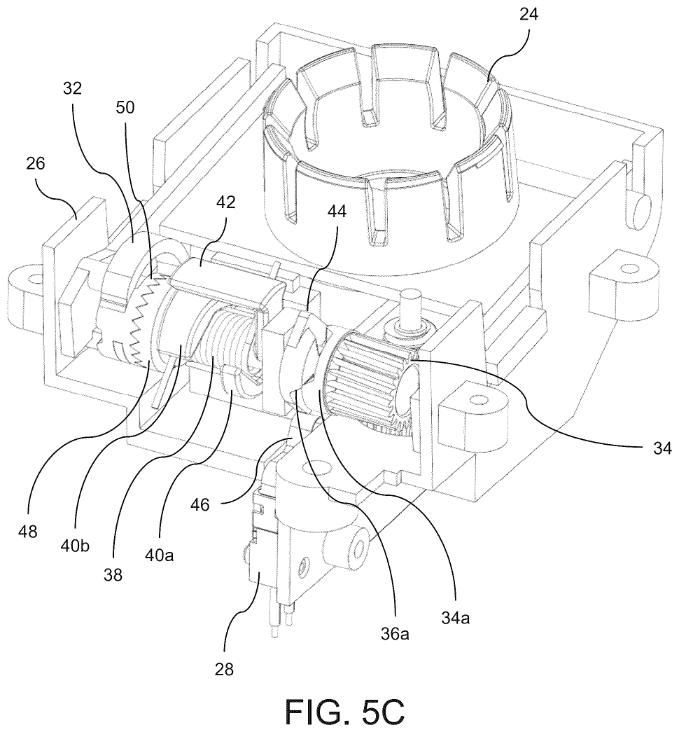

As shown in FIG. 5A, with the mirror head 12 in the nighttime orientation (e.g., pivoted upward five degrees from the daytime orientation), the torsion spring 38 is wound and energy is stored by the torque mechanism 30. The detent 34a of the main gear 34 is engaged with the detent 36a of the torque element 36 and thus the main gear 34 and gear train hold the spring load. The first clutch element 48 is disengaged from the second clutch element 50 such that there is no spring load through the cam 32 and a detent interface between the cam 32 and the toggle body 26 is engaged to prevent rotation of the cam 32 and movement of the mirror head 12 between positions. The contact 44 is compressing the limit switch 46 and thus the motor 28 is not operating.

After the torque mechanism 30 is released to adjust the mirror head 12 from the nighttime orientation to the daytime orientation (FIG. 5B), the main gear 34 rides along the detent 36a of the torque element 36 and the biasing element 52 urges the second clutch element 50 and the cam 32 out of engagement with the first clutch element 48. Thus, the torsion spring 38 is not wound and the main gear 34 is in the detent position and the first clutch element 48 is disengaged from the second clutch element 50 such that there is no torsion spring load through the cam 32. The cam 32 is in the detent position with the toggle body 26. The limit switch 46 is not pressed.

With the mirror head 12 adjusted to the daytime orientation (FIG. 5C), the motor 28 is operated to wind the torsion spring 38 and store energy in the torque mechanism 30. The detent interface 34a of the main gear 34 is at a peak in the detent interface 36a of the torque element 36 and the second clutch element 50 at the cam 32 is engaged with the first clutch element 48 at the torque element 36 and the cam 32 is not in the detent position with the toggle body 26. The limit switch 46 is not pressed.

The toggle actuator 20 may be actuated to release the spring load and adjust the mirror head 12 between the daytime orientation and the nighttime orientation responsive to any suitable input. For example, the mirror may be adjusted between orientations in response to a user input (e.g., flipping a toggle switch at the mirror head, a voice command, activating headlights of the vehicle, and the like) or in response to detection of glare light at the mirror reflective element 16. For example, a glare light sensor may be disposed at the mirror head (such as viewing through the mirror reflective element), and based on detection of glare light at the mirror reflective element 16, the toggle actuator 20 is actuated to adjust the mirror head from the daytime orientation to the nighttime orientation. Responsive to determining absence of glare light at the mirror reflective element 16, the toggle actuator 20 may be actuated to adjust the mirror head 12 back to the daytime orientation. Optionally, the toggle actuator 20 may be actuated to adjust the mirror head between positions based on determined ambient light levels within the cabin of the vehicle.

After the orientation of the mirror head is adjusted, the actuator 20 may be operated to slowly rewind the torsion spring 38 in the opposite direction without readjusting the mirror head orientation. The actuator 20 stops when the limit switch 46 is pressed and the actuator 20 is ready for the next instance of adjusting position of the mirror head 12. Operating the actuator 20 slowly between adjustments stores the energy over a longer period, which decreases amplitude of vibrations during operation of the motor 28 and reduces or eliminates sound that reaches the driver. For example, a cycle of operating the motor 28 to prime the actuator 20 may last 1 second or more, 2 seconds or more, 5 seconds or more, 10 seconds or more and the like. Further, the mirror head may adjust between the daytime orientation and the nighttime orientation quickly without any interaction required by the driver. For example, once actuated, the actuator 20 may adjust the mirror between the daytime orientation and the nighttime in less than 1 second, less than 0.5 seconds, less than 0.25 seconds and the like. This may reduce cost for automatic glare reduction over electrochromic technology.

Thus, the toggle actuator 20 may adjust the mirror head 12 between the daytime mode and the orientation mode (such as 5 degrees between orientations). This may replace standard tab flip mirrors. The actuator 20 adjusts the orientation automatically, such as based on feedback from glare sensors present in the mirror head. With the torsion spring 38 wound, the main gear 34 may only need to rotate an additional 10 degrees or less to release the spring, which results in quick adjustment of the mirror head between orientations (such as about 0.25 seconds or less). Further, because the output cam 32 is not directly connected to operation of the gear train, any backlash in the gearing does not have an effect on vibration performance at the mirror reflective element. The gear train may provide any suitable gear ratio between the motor and the main gear to adjust the time needed to wind the torsion spring 38. A slower wind may provide a quieter actuator with fewer or no vibrations at the mirror reflective element. Movement of the mirror head between orientations via the actuator may be accomplished, such as by utilizing characteristics of U.S. Pat. No. 10,442,360, which is incorporated herein by reference in its entirety.

In some examples, a display screen is disposed behind the mirror reflective element. In these examples, the mirror head may be adjustable between a mirror mode orientation (e.g., the daytime orientation and/or the nighttime orientation) and a display mode orientation, where the mirror head may be pivoted to direct reflections away from the view of the driver and the display screen may be operated to display video images viewable by the driver through the mirror reflective element. That is, the mirror head may be pivoted only between a mirror mode orientation and the display mode orientation (e.g., from the daytime orientation to the display mode orientation) or the mirror head may be pivoted from the nighttime orientation further from the daytime orientation (e.g., an additional 5 degrees of rotation for a total of 10 degrees from the daytime orientation) to the display mode orientation. The mirror head may be manually pivoted from the nighttime orientation to the display mode orientation, or the actuator may pivot the mirror head to the display mode orientation. Optionally, the video display screen may be operated to display the video images with the mirror head in the daytime orientation and/or the nighttime orientation. The prismatic mirror assembly with the video display screen may include characteristics of the mirror assemblies described in U.S. patent application Ser. No. 18/966,218, filed Dec. 3, 2024 (Attorney Docket DON01 P5276), which is hereby incorporated herein by reference in its entirety.

The interior mirror assembly may include a dual-mode interior rearview video mirror that can switch from a traditional reflection mode to a live-video display mode, such as is by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2021-0162926; US-2021-0155167; US-2020-0377022; US-2019-0258131; US-2019-0146297; US-2019-0118717 and/or US-2017-0355312, which are all hereby incorporated herein by reference in their entireties. The video display screen of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety. The operating mode of the mirror and video display screen may be selected by flipping the mirror head upward or downward (e.g., via a toggle located at the mirror head) or responsive to another user input. When the mirror is operating in the mirror mode, the video display screen is deactivated and rendered covert by the mirror reflective element, and the driver views rearward via reflection of light incident at the mirror reflective element. When the mirror is operating in the display mode, the video display screen is operated to display video images that are viewable through the mirror reflective element by the driver of the vehicle.

The reflective element and mirror casing are adjustable relative to a base portion or mounting assembly to adjust the driver's rearward field of view when the mirror assembly is normally mounted at or in the vehicle. The mounting assembly may comprise a single-ball or single-pivot mounting assembly, whereby the reflective element and casing are adjustable relative to the vehicle windshield (or other interior portion of the vehicle) about a single pivot joint, or the mounting assembly may comprise other types of mounting configurations, such as a double-ball or double-pivot mounting configuration or the like. The socket or pivot element is configured to receive a ball member of the base portion, such as for a single pivot or single ball mounting structure or a double pivot or double ball mounting structure or the like (such as a pivot mounting assembly of the types described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860 and/or 6,483,438, which are hereby incorporated herein by reference in their entireties).

The mounting base includes an attaching portion that is configured to be attached to an interior surface of a vehicle windshield (such as to a mounting button or attachment element adhered to the interior surface of the vehicle windshield or such as to a headliner or overhead console of the vehicle). The mounting base may comprise a metallic ball portion or may comprise a molded (such as injection molded) polymeric mounting base or may be otherwise formed, depending on the particular application of the mirror assembly.

The prismatic mirror assembly may be mounted or attached at an interior portion of a vehicle (such as at an interior surface of a vehicle windshield) via the mounting means described above, and the toggle mechanism may utilize aspects of the mirror assemblies described in U.S. Pat. Nos. 6,318,870 and/or 7,249,860, and/or U.S. Publication No. US-2010-0085653, which are hereby incorporated herein by reference in their entireties. Optionally, for example, the interior rearview mirror assembly may utilize aspects of the mirror assemblies described in U.S. Pat. Nos. 7,289,037; 7,249,860; 6,318,870; 6,598,980; 5,327,288; 4,948,242; 4,826,289; 4,436,371 and/or 4,435,042, which are hereby incorporated herein by reference in their entireties. Optionally, the prismatic reflective element may comprise a conventional prismatic reflective element or prism or may comprise a prismatic reflective element of the types described in U.S. Pat. Nos. 7,420,756; 7,289,037; 7,274,501; 7,249,860; 7,338,177 and/or 7,255,451, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular interior rearview mirror assembly, the vehicular interior rearview mirror assembly comprising:
a mirror head adjustable about a mounting base, wherein the mounting base is configured to mount the vehicular interior rearview mirror assembly to an interior portion of an interior cabin of a vehicle;
wherein the mirror head accommodates a mirror reflective element;
wherein, with the vehicular interior rearview mirror assembly mounted at the interior portion of the interior cabin of the vehicle, the mirror head is adjustable by a driver of the vehicle to set a rearward view for the driver;
an adjustment mechanism that, with the vehicular interior rearview mirror assembly mounted at the interior portion of the interior cabin of the vehicle, is operable to adjust the mirror head between at least (i) a first orientation where the mirror head is disposed at a first position relative to the mounting base and (ii) a second orientation where the mirror head is tilted from the first position to a second position relative to the mounting base different from the first position;
wherein the adjustment mechanism comprises (i) an electrically operable motor that drives a main gear, (ii) a torque element, (iii) an output element coupled to the mirror head and (iv) a biasing element coupled to the torque element;
wherein, with the mirror head in the first orientation, and during a first stage of electrical operation of the electrically operable motor, the electrically operable motor drives the main gear in a first direction and imparts movement of the torque element and the biasing element relative to the output element to generate a biasing force of the biasing element at the torque element; and
wherein, with the mirror head in the first orientation, and when the electrically operable motor is operating to adjust the mirror head from the first orientation to the second orientation, and during a second stage of electrical operation of the electrically operable motor following the first stage, the electrically operable motor drives the main gear further in the first direction to disengage the main gear from the torque element, whereby the biasing force of the biasing element imparts movement of the torque element and the output element to adjust the mirror head from the first orientation to the second orientation.

2. The vehicular interior rearview mirror assembly of claim 1, wherein, with the mirror head in the first orientation, and with the biasing force of the biasing element generated at the torque element, and with the electrically operable motor not being electrically operated to drive the main gear, the torque element is engaged with the main gear so that the biasing force of the biasing element is maintained at the torque element and the mirror head is maintained in the first orientation.

3. The vehicular interior rearview mirror assembly of claim 1, wherein the electrically operable motor is electrically operated during the second stage based on an input.

4. The vehicular interior rearview mirror assembly of claim 3, wherein the input comprises a user input.

5. The vehicular interior rearview mirror assembly of claim 3, wherein the input is responsive to detection of glare light incident at the mirror reflective element.

6. The vehicular interior rearview mirror assembly of claim 1, wherein, with the mirror head in the second orientation, and during a third stage of electrical operation of the electrically operable motor, the electrically operable motor drives the main gear in a second direction and imparts movement of the torque element and the biasing element relative to the output element to generate the biasing force of the biasing element at the torque element, and wherein the second direction is opposite the first direction.

7. The vehicular interior rearview mirror assembly of claim 6, wherein with the mirror head in the second orientation, and when the electrically operable motor is operating to adjust the mirror head from the second orientation to the first orientation, and during a fourth stage of electrical operation of the electrically operable motor following the third stage, the electrically operable motor drives the main gear further in the second direction to disengage the main gear from the torque element, whereby the biasing force of the biasing element imparts movement of the torque element and the output element to adjust the mirror head from the second orientation to the first orientation.

8. The vehicular interior rearview mirror assembly of claim 1, wherein a detent interface is disposed between the main gear and the torque element, and wherein, as the electrically operable motor is electrically operated during the first stage, the detent interface is engaged and the main gear imparts movement of the torque element and the biasing element in the first direction relative to the output element to generate the biasing force of the biasing element at the torque element, and wherein, as the electrically operable motor is electrically operated during the second stage, the detent interface disengages and the biasing force of the biasing element imparts movement of the torque element and the output element relative to the main gear.

9. The vehicular interior rearview mirror assembly of claim 1, wherein a clutch interface is disposed between the torque element and the output element, and wherein, as the electrically operable motor is electrically operated during the first stage, the clutch interface is not engaged and the main gear and the torque element move relative to the output element.

10. The vehicular interior rearview mirror assembly of claim 9, wherein, responsive to electrical operation of the electrically operable motor during the second stage, the clutch interface is engaged and the biasing force of the biasing element imparts movement of the torque element and the output element relative to the main gear.

11. The vehicular interior rearview mirror assembly of claim 10, wherein the clutch interface is engaged responsive to the main gear being disengaged from the torque element.

12. The vehicular interior rearview mirror assembly of claim 1, wherein the electrically operable motor rotatably drives the main gear.

13. The vehicular interior rearview mirror assembly of claim 12, wherein electrical operation of the electrically operable motor during the first stage drives the main gear to impart rotational movement of the torque element and the biasing element relative to the output element.

14. The vehicular interior rearview mirror assembly of claim 12, wherein responsive to electrical operation of the electrically operable motor during the second stage, and responsive to the main gear being disengaged from the torque element, the biasing force of the biasing element imparts rotational movement of the torque element and the output element relative to the main gear.

15. The vehicular interior rearview mirror assembly of claim 1, wherein the biasing element comprises a torsion spring.

16. The vehicular interior rearview mirror assembly of claim 1, wherein the mirror reflective element comprises a prismatic mirror reflective element, and wherein the prismatic mirror reflective element comprises a wedge-shaped glass substrate and a mirror reflector coating disposed at a rear side of the wedge-shaped glass substrate, and wherein the first orientation comprises a daytime orientation where reflections at the mirror reflector coating provide the rearward view for the driver, and wherein the second orientation comprises a nighttime orientation where reflections at the mirror reflector coating are directed away from the driver.

17. The vehicular interior rearview mirror assembly of claim 1, wherein the mirror head accommodates a video mirror display screen that, when electrically operated, displays video images that are viewable through the mirror reflective element by the driver of the vehicle, and wherein the first orientation comprises a mirror mode orientation where reflections at a mirror reflector coating of the mirror reflective element provide the rearward view for the driver, and wherein the second orientation comprises a video display mode orientation where reflections at the mirror reflector coating are directed away from the driver and the video mirror display screen is electrically operated to display video images for viewing by the driver of the vehicle.

18. A vehicular interior prismatic rearview mirror assembly, the vehicular interior prismatic rearview mirror assembly comprising:
a mirror head adjustable about a mounting base, wherein the mounting base is configured to mount the vehicular interior prismatic rearview mirror assembly to an interior portion of an interior cabin of a vehicle;
wherein the mirror head accommodates a prismatic mirror reflective element;
wherein the prismatic mirror reflective element comprises a wedge-shaped glass substrate and a mirror reflector coating disposed at a rear side of the wedge-shaped glass substrate;
wherein, with the vehicular interior prismatic rearview mirror assembly mounted at the interior portion of the interior cabin of the vehicle, the mirror head is adjustable by a driver of the vehicle to set a rearward view for the driver;
an adjustment mechanism that, with the vehicular interior prismatic rearview mirror assembly mounted at the interior portion of the interior cabin of the vehicle, is operable to adjust the mirror head between at least (i) a daytime orientation where the mirror head is positioned relative to the mounting base so that reflections at the mirror reflector coating provide the rearward view for the driver and (ii) a nighttime orientation where the mirror head is tilted from the daytime orientation so that reflections at the mirror reflector coating are directed away from the driver;
wherein the adjustment mechanism comprises (i) an electrically operable motor that drives a main gear, (ii) a torque element, (iii) an output element coupled to the mirror head and (iv) a biasing element coupled to the torque element;
wherein, with the mirror head in the daytime orientation, and during a first stage of electrical operation of the electrically operable motor, the electrically operable motor drives the main gear in a first direction and imparts movement of the torque element and the biasing element relative to the output element to generate a biasing force of the biasing element at the torque element;
wherein, with the mirror head in the daytime orientation, and with the biasing force of the biasing element generated at the torque element, and with the electrically operable motor not being electrically operated to drive the main gear, the torque element is engaged with the main gear so that the biasing force of the biasing element is maintained at the torque element and the mirror head is maintained in the daytime orientation; and
wherein, with the mirror head in the daytime orientation, and when the electrically operable motor is operating to adjust the mirror head from the daytime orientation to the nighttime orientation, and during a second stage of electrical operation of the electrically operable motor following the first stage, the electrically operable motor drives the main gear further in the first direction to disengage the main gear from the torque element, whereby the biasing force of the biasing element imparts movement of the torque element and the output element to adjust the mirror head from the daytime orientation to the nighttime orientation.

19. The vehicular interior prismatic rearview mirror assembly of claim 18, wherein the electrically operable motor is electrically operated during the second stage based on an input.

20. The vehicular interior prismatic rearview mirror assembly of claim 19, wherein the input comprises a user input.

21. The vehicular interior prismatic rearview mirror assembly of claim 19, wherein the input is responsive to detection of glare light incident at the prismatic mirror reflective element.

22. The vehicular interior prismatic rearview mirror assembly of claim 18, wherein, with the mirror head in the nighttime orientation, and during a third stage of electrical operation of the electrically operable motor, the electrically operable motor drives the main gear in a second direction and imparts movement of the torque element and the biasing element relative to the output element to generate the biasing force of the biasing element at the torque element, and wherein the second direction is opposite the first direction, and wherein with the mirror head in the nighttime orientation, and when the electrically operable motor is operating to adjust the mirror head from the nighttime orientation to the daytime orientation, and during a fourth stage of electrical operation of the electrically operable motor following the third stage, the electrically operable motor drives the main gear further in the second direction to disengage the main gear from the torque element, whereby the biasing force of the biasing element imparts movement of the torque element and the output element to adjust the mirror head from the nighttime orientation to the daytime orientation.

23. The vehicular interior prismatic rearview mirror assembly of claim 18, wherein a detent interface is disposed between the main gear and the torque element, and wherein, as the electrically operable motor is electrically operated during the first stage, the detent interface is engaged and the main gear imparts movement of the torque element and the biasing element in the first direction relative to the output element to generate the biasing force of the biasing element at the torque element, and wherein, as the electrically operable motor is electrically operated during the second stage, the detent interface disengages and the biasing force of the biasing element imparts movement of the torque element and the output element relative to the main gear.

24. The vehicular interior prismatic rearview mirror assembly of claim 18, wherein a clutch interface is disposed between the torque element and the output element, and wherein, as the electrically operable motor is electrically operated during the first stage, the clutch interface is not engaged and the main gear and the torque element move relative to the output element.

25. The vehicular interior prismatic rearview mirror assembly of claim 18, wherein the biasing element comprises a torsion spring.

26. A vehicular interior rearview mirror assembly, the vehicular interior rearview mirror assembly comprising:
a mirror head adjustable about a mounting base, wherein the mounting base is configured to mount the vehicular interior rearview mirror assembly to an interior portion of an interior cabin of a vehicle;
wherein the mirror head accommodates a mirror reflective element;
wherein, with the vehicular interior rearview mirror assembly mounted at the interior portion of the interior cabin of the vehicle, the mirror head is adjustable by a driver of the vehicle to set a rearward view for the driver;
a video mirror display screen accommodated by the mirror head, wherein, with the vehicular interior rearview mirror assembly mounted at the interior portion of the interior cabin of the vehicle, the video mirror display screen, when electrically operated, displays video images that are viewable through the mirror reflective element by the driver of the vehicle;
an adjustment mechanism that, with the vehicular interior rearview mirror assembly mounted at the interior portion of the interior cabin of the vehicle, is operable to adjust the mirror head between at least (i) a mirror mode orientation where the mirror head is positioned relative to the mounting base so that reflections at a mirror reflector coating of the mirror reflective element provide the rearward view for the driver and (ii) a video display mode orientation where the mirror head is tilted from the mirror mode orientation so that reflections at the mirror reflector coating are directed away from the driver and the video mirror display screen is electrically operated to display video images for viewing by the driver of the vehicle;
wherein the adjustment mechanism comprises (i) an electrically operable motor that drives a main gear, (ii) a torque element, (iii) an output element coupled to the mirror head and (iv) a biasing element coupled to the torque element;
wherein, with the mirror head in the mirror mode orientation, and during a first stage of electrical operation of the electrically operable motor, the electrically operable motor drives the main gear in a first direction and imparts movement of the torque element and the biasing element relative to the output element to generate a biasing force of the biasing element at the torque element;
wherein, with the mirror head in the mirror mode orientation, and with the biasing force of the biasing element generated at the torque element, and with the electrically operable motor not being electrically operated to drive the main gear, the torque element is engaged with the main gear so that the biasing force of the biasing element is maintained at the torque element and the mirror head is maintained in the mirror mode orientation; and
wherein, with the mirror head in the mirror mode orientation, and when the electrically operable motor is operating to adjust the mirror head from the mirror mode orientation to the video display mode orientation, and during a second stage of electrical operation of the electrically operable motor following the first stage, the electrically operable motor drives the main gear further in the first direction to disengage the main gear from the torque element, whereby the biasing force of the biasing element imparts movement of the torque element and the output element to adjust the mirror head from the mirror mode orientation to the video display mode orientation.

27. The vehicular interior rearview mirror assembly of claim 26, wherein the electrically operable motor is electrically operated during the second stage based on an input.

28. The vehicular interior rearview mirror assembly of claim 27, wherein the input comprises a user input.

29. The vehicular interior rearview mirror assembly of claim 27, wherein the input is responsive to detection of glare light incident at the mirror reflective element.

30. The vehicular interior rearview mirror assembly of claim 26, wherein, with the mirror head in the video display mode orientation, and during a third stage of electrical operation of the electrically operable motor, the electrically operable motor drives the main gear in a second direction and imparts movement of the torque element and the biasing element relative to the output element to generate the biasing force of the biasing element at the torque element, and wherein the second direction is opposite the first direction, and wherein with the mirror head in the video display mode orientation, and when the electrically operable motor is operating to adjust the mirror head from the video display mode orientation to the mirror mode orientation, and during a fourth stage of electrical operation of the electrically operable motor following the third stage, the electrically operable motor drives the main gear further in the second direction to disengage the main gear from the torque element, whereby the biasing force of the biasing element imparts movement of the torque element and the output element to adjust the mirror head from the video display mode orientation to the mirror mode orientation.

31. The vehicular interior rearview mirror assembly of claim 26, wherein a detent interface is disposed between the main gear and the torque element, and wherein, as the electrically operable motor is electrically operated during the first stage, the detent interface is engaged and the main gear imparts movement of the torque element and the biasing element in the first direction relative to the output element to generate the biasing force of the biasing element at the torque element, and wherein, as the electrically operable motor is electrically operated during the second stage, the detent interface disengages and the biasing force of the biasing element imparts movement of the torque element and the output element relative to the main gear.

32. The vehicular interior rearview mirror assembly of claim 26, wherein a clutch interface is disposed between the torque element and the output element, and wherein, as the electrically operable motor is electrically operated during the first stage, the clutch interface is not engaged and the main gear and the torque element move relative to the output element.
